(19) United States
(12) Patent Application Publication
(10) Pub. No.: US 2016/0044388 A1
(43) Pub. Date: Feb. 11, 2016

(54) GENERATION AND DELIVERY OF A STREAM REPRESENTING AUDIOVISUAL CONTENT

(71) Applicant: ORANGE, Paris (JP)

(72) Inventors: Chantal Guionnet, Cesson Sevigne (FR); Pierre Fevrier, St Sulpice La Foret (FR)

(21) Appl. No.: 14/773,745

(22) PCT Filed: Mar. 21, 2014
(86) PCT No.: PCT/FR2014/050660

§ 371 Date: Sep. 8, 2015

(30) Foreign Application Priority Data
Mar. 26, 2013 (FR) 1352706

(51) Int. Cl. H04N 21/8549; H04N 21/845; G11B 27/10

(52) U.S. Cl. CPC H04N 21/8549; G11B 27/10; H04N 21/8456

(57) ABSTRACT

The invention provides a generation method for generating a stream (F) representative of an audiovisual content (CA) suitable for being broadcast by a broadcast network, the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined sequences with start and end of sequence markers; and
adding (E5) said markers to the stream for broadcasting.

### FIELD OF THE INVENTION

The field of the invention is that of telecommunications, and more particularly broadcasting streams representative of audiovisual contents via a broadcast network to terminals that are suitable for playing back such contents.

### PRESENTATION OF THE PRIOR ART

Nowadays, when a stream representative of an audiovisual content is broadcast in real time via a broadcast network to a content playback terminal, such as for example a digital television receiver fitted with a set-top-box type decoder, the entire audiovisual content can be stored, e.g. in the decoder, in order to be viewed subsequently by the user.

When the user seeks later on to view one particular stored audiovisual content from among others, the user may have difficulties in deciding which particular stored audiovisual content to select. In order to decide on one particular content rather than another, the user may be obliged to view some or all of the previously stored contents for a few moments. Such manipulation is not ergonomic and wastes time. In order to decide on a particular content, the user can also connect to a dedicated Internet site in order to recover a summary of the audiovisual content that has been stored, e.g. a trailer. Such manipulation is likewise not very practical, since the user must then necessarily have an Internet connection. Furthermore, such manipulation is often available only for certain types of audiovisual content, and in particular films. When the user seeks for example to view a concert, a television broadcast, etc. . . . , extracts of that type of content are not always available.

### OBJECT AND SUMMARY OF THE INVENTION

One of the objects of the invention is to remedy those above-mentioned drawbacks of the state of the art.

To this end, in one aspect, the present invention provides a method of generating a stream representative of an audiovisual content suitable for being broadcast by a broadcast network.

Such a method is remarkable in that, prior to broadcasting the content, it comprises the following steps:
determining a plurality of time sequences in the audiovisual content;
associating each of the determined time sequences with start and end of sequence markers; and
adding the markers to the stream for broadcasting.

Such a provision enables a user, who has previously stored an audiovisual content taken from a broadcast stream via the broadcast network, to have the option of viewing either the stored audiovisual content in full or else to view a summary associated with that audiovisual content. The summary is advantageously viewed by running on the various sequences identified by their respective start and end of sequence markers.

In particularly advantageous manner, the summary of the audiovisual content is included in the audiovisual content itself, thereby avoiding any broadcasting or downloading in parallel of a summary of the content.

In addition, such a provision makes it possible to ensure that the summary is always available, regardless of the type of audiovisual content that has been stored.

In a particular implementation, the start and end of time sequence markers are added either to the data of the audiovisual content or in broadcast parameters associated with the stream for broadcasting.

When playing back the summary of the audiovisual content, such a provision makes it possible to cause the time sequences to run on in automatic and very fluid manner, without any interruption of viewing for the user.

In particularly advantageous manner, a user, who desires to view the summary of an audiovisual content that has previously been broadcast and then recorded or downloaded, does not have any need to select personally the time sequences of the audiovisual content, and does not have any need to run those sequences on one after another. Such operations are specified by the supplier of audiovisual contents, prior to broadcasting the audiovisual content.

In another particular implementation, each of the time sequences is numbered in a predetermined order.

When viewing a summary of an audiovisual content, e.g. the trailer of a film, such a provision makes it possible to avoid the time sequences being run on linearly in the time order in which they occur in the content. Thus, the summary or trailer may be characterized depending on the desires of the supplier or provider of audiovisual contents so that it begins in the summary/trailer of the film by showing the final scene of the film, and only then returning to a plurality of different time sequences of the film, not necessarily in order, so as to surprise the user without necessarily revealing all the content.

In yet another particular implementation, the generation method of the invention further comprises the following steps:
determining another plurality of time sequences different from the above-mentioned plurality of time sequences in the above-mentioned audiovisual content;
associating each of the determined time sequences of the other plurality with corresponding start and end of sequence markers; and
adding the corresponding markers to the stream for broadcasting.

Such a provision makes it possible to activate a plurality of summaries of different types with the same audiovisual content, which types can satisfy different desires of the user or of the supplier of audiovisual contents. For example, for a given audiovisual content, the user can thus view either a summary showing the main milestones of the content, or else a summary that reveals only the atmosphere of the content, or a summary that reveals only scenes in which the user's preferred character appears, etc. . . . .

In particularly advantageous manner, such summaries of different types are easily identifiable in the broadcast stream, in particular because of the start and end of sequence markers that characterize each plurality of time sequences.

In yet another particular implement, the generation method in accordance with the invention further comprises the following steps:
associating audio data with at least one of the determined time sequences; and
adding the audio data to the stream for broadcasting.

Such a provision serves to enrich the viewing of a summary of the audiovisual content by making it possible while viewing a given time sequence:
either to add audio data that is synchronized with the time sequence, e.g. particular music;
or else to replace the audio data of the time sequence with audio data that is synchronized therewith, e.g. in a language different from the language of the original version of the audiovisual content.

The invention also provides a generator device for generating a stream representative of an audiovisual content suitable for being broadcast by a broadcast network, such a device being adapted to perform the above-described generation method.

Such a generator device is remarkable in that it comprises the following modules suitable for being activated prior to broadcasting the above-mentioned audiovisual content:
a determination module for determining a plurality of time sequences in the audiovisual content;
an association module for associating each of the determined time sequences with start and end of sequence markers; and
an insertion module for adding the markers to the stream for broadcasting.

The invention also provides a telecommunications signal carrying a stream representative of an audiovisual content for broadcasting over a broadcast network.

Such a signal is remarkable in that it includes a plurality of time sequences respectively associated with start and end of sequence markers, the sequences and markers being provided by the above-specified generation method.

The invention also provides a playback method for playing back a stream representative of an audiovisual content, such a stream being generated by the above-specified generation method.

Such a playback method is remarkable in that it comprises the following steps:
accessing the above-mentioned stream;
from the above-mentioned stream, selecting the audiovisual content in full, or else selecting the plurality of time sequences of the audiovisual content by identifying start and end of sequence markers in the stream that are respectively associated with each of the time sequences; and
causing the selected audiovisual content to be read in full or else the selected plurality of time sequences to be read.

In a particular implementation, the step of causing selected content to be read consists in running one after another each of the time sequences corresponding respectively to each of the identified start and end of sequence markers.

In another particular implementation, the identified time sequences are selected in a predetermined numbering order.

In yet another particular implementation, during the step of selecting the plurality of time sequences of the audiovisual content, audio data is identified for at least one of the selected time sequences and is associated with that at least one time sequence, with the playback of this at least one time sequence involving simultaneously playing back the audio data that is associated with this at least one time sequence.

In yet another particular implementation, the playback method of the invention includes, after the step of accessing the above-mentioned stream, the following steps:
from the above-mentioned stream, selecting another plurality of time sequences of the audiovisual content different from the above-mentioned plurality of time sequences by identifying start and end of sequence markers in the stream that are associated respectively with each of the time sequences of this other plurality; and
causing this other selected plurality of time sequences to be read.

The invention also provides a device for playing back a stream representative of an audiovisual content, such a device being adapted to perform the above-mentioned playback method.

Such a playback method is remarkable in that it comprises the following modules:
an access module for accessing the above-mentioned stream;
a selection module for selecting from the above-mentioned stream the audiovisual content in full or else the plurality of time sequences of the audiovisual content by identifying start and end of sequence markers in the stream that are associated respectively with each of the time sequences; and
a read control module for reading the selected audiovisual content in full or else for reading the selected plurality of time sequences.

The invention also provides a computer program including instructions for performing the generation method of the invention when executed on a computer.

The invention also provides a computer program including instructions for implementing the playback method of the invention when executed on a computer.

Each of the programs may use any programming language and may be in the form of source code, object code, or code intermediate between source code and object code, such as in a partially compiled form, or in any other desirable form.

The invention also provides a computer readable data medium containing a computer program, the program including instructions adapted to perform the generation method of the invention, as described above.

The invention also provides a computer readable data medium containing a computer program, the program including instructions adapted to perform the playback method of the invention, as described above.

Each of these data media may be any kind of entity or device capable of storing the program. For example, the medium may comprise storage means such as a read only memory (ROM), e.g. a compact disk (CD) ROM or a microelectronic circuit ROM, or indeed magnetic recording means, e.g. a hard disk or a universal serial bus (USB) key.

Furthermore, each of the data media may be a transmissible medium such as an electrical or optical signal, suitable for being conveyed via an electrical or optical cable, by radio, or by other means. The programs of the invention may in particular be downloaded from an Internet type network.

Alternatively, the data medium may be an integrated circuit in which the program is incorporated, the circuit being adapted to execute or to be used in the execution of the above-mentioned generation or playback method.

The generation device, the telecommunications signal, the playback method, the playback device, and the above-mentioned corresponding computer programs present at least the same advantages as those conferred by the generation method of the present invention.

### LIST OF FIGURES

Other advantages and characteristics of the invention appear more clearly on reading the following description of a particular implementation of the invention, given merely by way of non-limiting illustration, and from the accompanying drawings, in which:

FIG. 1 is a diagram of a system of the invention for broadcasting an audiovisual signal;

FIG. 2 is a diagram of the steps of a method of the invention for generating an audiovisual stream;

FIGS. 3a to 3d are diagrams showing the structure of a signal carrying an audiovisual data stream in four implementations of the invention;

FIG. 4 is a diagram showing the steps of a method of the invention for playing back an audiovisual stream;

FIGS. 5a to 5c show examples of interfaces displayed on a user's television set when the playback method of FIG. 4 is performed;

FIG. 6 shows a simplified structure for a device for generating an audiovisual stream in an embodiment of the invention; and

FIG. 7 shows a simplified structure for a playback device for playing back a first audiovisual stream in an embodiment of the invention.

### DESCRIPTION OF A PARTICULAR IMPLEMENTATION OF THE INVENTION

The general principle of the invention relies on inserting a plurality of markers into a stream representative of an audiovisual content that is to be broadcast subsequently or that is being broadcast, the markers marking the starts and the ends of time sequences. A stream as constituted in this way enables a user who has previously accessed the broadcast stream to act, when playing back the content associated with the stream, to select directly either to view the audiovisual content in full, or else to view a summary of the audiovisual content as constituted solely by concatenating the above-mentioned time sequences.

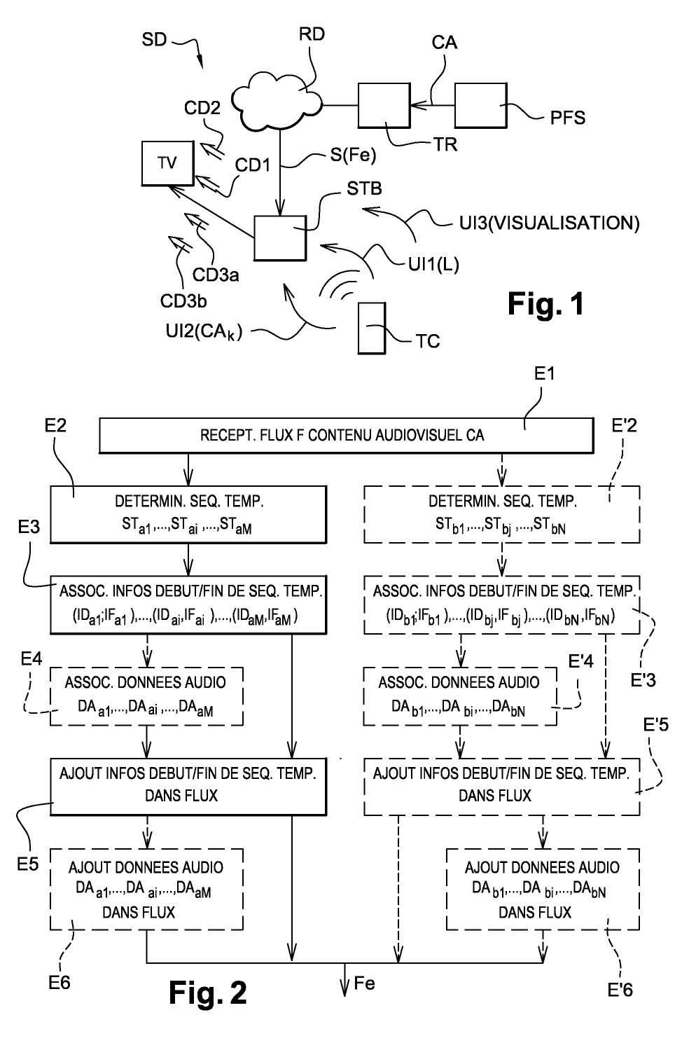

With reference to FIG. 1, there can be seen a broadcast system SD for broadcasting a data stream coding audiovisual contents broadcast by headend server equipment TR. In known manner, such streams are broadcast e.g. by radio, or by satellite, or by IP multicast, in compliance with a digital TV standard, such as the digital video broadcasting (DVB) standard.

The headend TR communicates with a service platform PFS to which a user has previously subscribed, so as to be able to access audiovisual contents proposed by the service platform.

For this purpose, the broadcast system SD has an access terminal STB giving access to the streams representative of such audiovisual contents, such as an access terminal being suitable for receiving said streams, for processing them, and for playing them back to a user. The access terminal includes, or in some circumstances is connected to, a display terminal, e.g. a television set TV. The access terminal STB is also provided with means for storing audiovisual contents, in particular those that are broadcast by the network RD. Alternatively, it may also be connected to an external module for recording audiovisual contents.

The user can interact with the access terminal STB by means of a remote control TC that has buttons dedicated to prerecorded commands. For example, the user can select a previously received audiovisual content merely by pressing on arrow keys “←”, “→”, “↑”, “↓” in a menu associated with displaying received contents. The user can also confirm the selected audiovisual content by pressing an “OK” button. When the user activates a button of the remote control, a message including the command associated with that button is sent to the access terminal STB using a known and standardized communication protocol, e.g. an infrared remote control protocol of the remote control 5 (RC5) type, which is not described in detail herein.

Alternatively, a smart phone or a tablet fitted with an appropriate software application can advantageously replace the physical remote control. For example, the smart phone communicates with a remote server that sends a message to the access terminal STB conveying the command corresponding to the action selected by the user interacting with the remote control application.

With reference to FIG. 2, there follows a description of the steps of the method of generating an audiovisual stream as performed by the headend server equipment TR of FIG. 1, in an implementation of the invention.

During a step E1 shown in FIG. 2, the server equipment TR receives a data stream F from the platform PFS of FIG. 1, this stream being representative of an audiovisual content CA that is to be broadcast to the access terminal STB via the broadcast network RD. By way of example, such an audiovisual content consists in a film, a TV broadcast, a concert, a sports event, in particular such as a football match, etc. . . . .

During a step E2, shown in FIG. 2, the server equipment TR determines a plurality of time sequences STₐ₁, STₐ₂, . . . , STₐᵢ, . . . , ST_{aM}, with 1≦i≦M, in said stream F. Said time sequences follow one another in time in the audiovisual content CA and are representative of a first type of summary thereof.

In an example, such a determination step consists in selecting the time sequences of the audiovisual content that are to be used in constituting the summary or trailer of the first type. Such a summary or trailer of the first type may, for example, group together the most important milestones in the audiovisual content.

During a step E′2 shown in FIG. 2 that is optional, and therefore shown in dashed lines, the server equipment TR determines another plurality of time sequences ST_{b1}, ST_{b2}, . . . , ST_{bj}, . . . , ST_{bN}, with 1≦j≦N, in said stream F. Said time sequences follow one another in time in the audiovisual content CA and are representative of a second type of summary thereof.

In an example, such a determination step consists in selecting time sequences representative of milestones relating to the atmosphere of the audiovisual content.

In other examples, the time sequences could be representative of a short version of the audiovisual content or indeed of a longer version of the audiovisual content depending on the number and/or durations of the time sequences that are determined.

During a step E3 shown in FIG. 2, the server equipment TR associates start and end of sequence markers (IDₐ₁; IFₐ₁), (IDₐ₂, IFₐ₂), . . . , (IDₐᵢ; IFₐᵢ), . . . , (ID_{aM}, IF_{aM}) with each of said time sequences determined in above-described step E2.

During a step E′3 shown in FIG. 2 that is optional, and therefore drawn in dashed lines, the server equipment TR associates start and end of sequence markers (ID_{b1}; IF_{b1}), (ID_{b2}, IF_{b2}), . . . , (ID_{bi}; IF_{bj}), . . . , (ID_{bN}, IF_{bN}) with each of said time sequences determined in above-described step E′2.

The start and end of sequence markers (IDₐ₁; IFₐ₁), (IDₐ₂, IFₐ₂), . . . , (IDₐᵢ; IFₐᵢ), . . . , (ID_{aM}, F_{aM}) and indeed the start and end of sequence markers (ID_{b1}; IF_{b1}), (ID_{b2}, IF_{b2}), . . . , (ID_{bi}; IF_{bj}), . . . , (ID_{bN}, IF_{bN}) constitute type markers that make it possible, while playing back the audiovisual content, to identify in real time the particular first or second type of summary or trailer to which the time sequences being read belong.

Said determined time sequences are also each numbered in a predetermined order.

For a determined time sequence, the end of sequence marker may alternatively be a parameter that defines the duration of said sequence, in association with the start of sequence marker.

In a first variant implementation, the start and end of time sequence markers are added to the data stream F representative of the audiovisual content CA.

In a second variant implementation, the start and end of time sequence markers are added as broadcast parameters associated with said stream F.

During a step E4 shown in FIG. 2 that is optional, and therefore shown in dashed lines, the server equipment TR associates audio data with at least one of said time sequences determined in above-described step E2.

In the example shown, each of said time sequences determined in the step E2 is associated with respective audio data DAₐ₁, DAₐ₂, . . . , DAₐᵢ, . . . , DA_{aM}.

During a step E′4 shown in FIG. 2 that is optional, and therefore shown in dashed lines, the server equipment TR associates audio data with at least one of said time sequences determined in above-described step E′2.

In the example shown, each of said time sequences determined in step E′2 is respectively associated with audio data DA_{b1}, DA_{b2}, . . . , DA_{bj}, . . . , DA_{bN}.

In a first example, such audio data may for example be additional to the sound data present in each time sequence. For example, it may relate to dedicated music or to an explanatory commentary.

In a second example, such audio data may for example be for taking the place of the sound data present in each time sequence. By way of example, it may comprise a language desired by the user, which is different from the original language of the audiovisual content.

During a step E5 shown in FIG. 2, the server equipment TR adds the start and end of time sequence markers (IDₐ₁; IFₐ₁), (IDₐ₂, IFₐ₂), . . . , (IDₐᵢ; IFₐᵢ), . . . , (ID_{aM}, IF_{aM}) that it associated in step E3 with the stream F representative of the audiovisual content.

During a step E′5 shown in FIG. 2 that is optional, and therefore shown in dashed lines, the server equipment TR adds the start and end of time sequence markers (ID_{b1}; IF_{b1}), (ID_{b2}, IF_{b2}), . . . , (ID_{bi}; IF_{bj}), . . . , (ID_{bN}, IF_{bN}) that it associated in the step E′3 to the stream F representative of the audiovisual content.

During a step E6 shown in FIG. 2 that is optional, and therefore shown in dashed lines, the server equipment TR adds the audio data that it associated in step E4 to the stream F representative of the audiovisual content.

During a step E′6 shown in FIG. 2 that is optional, and therefore shown in dashed lines, the server equipment TR adds the audio data that it associated in step E′4 to the stream F representative of the audiovisual content.

At the end of step E5 and/or E′5, or indeed at the end of step E6 and/or E′6, an enriched stream Fe is delivered that is representative of the audiovisual content CA.

All of the above-described steps are performed prior to broadcasting the stream containing the audiovisual content.

Such steps may be performed well before the decision to broadcast the audiovisual content, for example when the content is a film.

In a variant, such steps may be performed in real time while broadcasting an audiovisual content, for example a sports event that is being broadcast live.

The stream Fe as generated in this way is suitable for being broadcast via the broadcast network RD to the access terminal STB shown in FIG. 1.

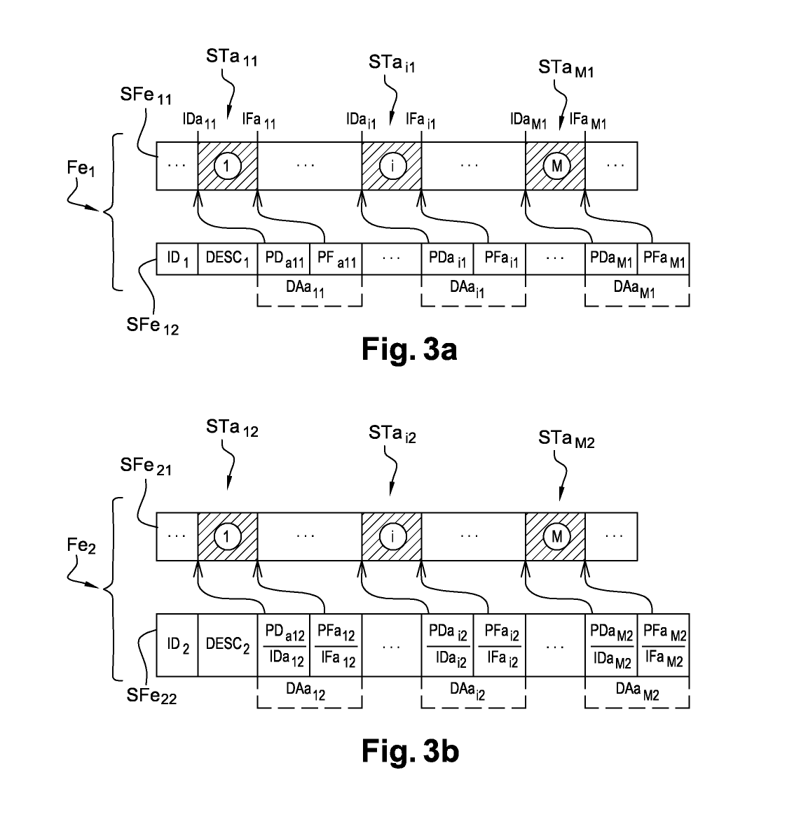

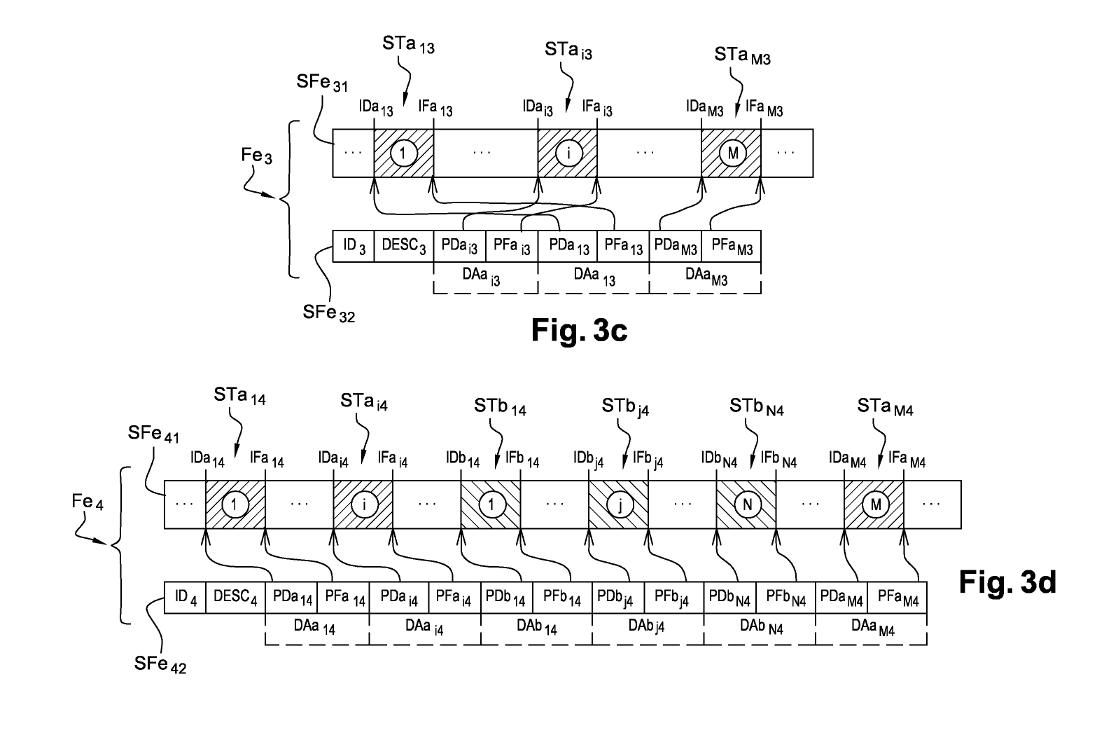

With reference to FIG. 1, the audiovisual content CA is conveyed by the broadcast network RD in a signal S carrying the enriched data stream Fe, which may be in various possible data structures as described below in outline with reference to FIGS. 3a, 3b, 3c, and 3d.

In a manner that is common to FIGS. 3a, 3b, 3c, and 3d, the stream Fe₁ shown in FIG. 3a (Fe₂, Fe₃, Fe₄ shown respectively in FIGS. 3b, 3c, and 3c) comprises a first sub-stream SFe₁₁ (SFe₂₁, SFe₃₁, SFe₄₁ respectively in FIGS. 3b, 3c, and 3d) containing the data coding the content CA and a second sub-stream for signaling SFe₁₂ (SFe₂₂, SFe₃₂, SFe₄₂ respectively in FIGS. 3b, 3c, and 3d) that contains information enabling the stream Fe₁ (respectively Fe₂, Fe₃, Fe₄) to be analyzed by the user's access terminal STB.

With reference to FIG. 3a, the signaling sub-stream SFe₁₂ contains, in conventional manner, at least one identifier ID₁ of the audiovisual content CA, description information DESC₁ of the audiovisual content CA, such as for example its genre, associated time information such as the start of broadcast time and the end of broadcast time.

With reference to FIG. 3a and in a first aspect of the invention, the first sub-stream SFe₁₁ also contains a plurality of time sequences STa₁₁, . . . , STaᵢ₁, . . . , STa_{M1}, that follow one another in time and that are identified respectively by the start and end of sequence markers (IDa₁₁; IFa₁₁), . . . , (IDaᵢ₁, IFaᵢ₁), . . . , IDa_{M1}; IFa_{M1}). Such time sequences are represented by diagonal shading in FIG. 3a.

For this purpose, the signaling sub-stream SFe₁₂ contains 2×M stream pointers (PDa₁₁; PFa₁₁), . . . , (PDaᵢ₁, PFaᵢ₁), . . . , (PDa_{M1}; PFa_{M1}) that are associated with respective start and end of sequence markers (IDa₁₁; IFa₁₁), . . . , (IDaᵢ₁, IFaᵢ₁), . . . , (IDa_{M1}; IFa_{M1}).

In an embodiment shown in FIG. 3b, the first sub-stream SFe₂₁ also contains a plurality of time sequences STa₁₂, . . . , STaᵢ₂, . . . , STa_{M2} that follow one another in time and that are identified by respective start and end of sequence markers (IDa₁₂; IFa₁₂), . . . , (IDaᵢ₂, IFaᵢ₂), . . . , (IDa_{M2}; IFa_{M2}). These markers are associated with respective stream pointers (PDa₁₂; PFa₁₂), . . . , (PDaᵢ₂, PFaᵢ₂), . . . , (PDa_{M2}; PFa_{M2}) directly in the signaling sub-stream SFe₂₂. Such time sequences are represented by diagonal shading in FIG. 3b.

In FIGS. 3a and 3b, the time sequences are numbered in the order in which they appear in the audiovisual content.

Optionally, and as explained above in the description, each of the time sequences STa₁₁, . . . , STaᵢ₁, . . . , STa_{M1} of FIG. 3a is associated with respective audio data DAa₁₁, . . . , DAaᵢ₁, . . . , DAa_{M1}. Such audio data is synchronized with the corresponding time sequence in the signaling sub-stream SFe₁₂.

Optionally, and as explained above in the description, each of the time sequences STa₁₂, . . . , STaᵢ₂, . . . , STa_{M2} of FIG. 3b is associated with respective audio data DAa₁₂, . . . , DAaᵢ₂, . . . , DAa_{M2}. Such audio data is synchronized with the corresponding time sequence in the signaling sub-stream SFe₂₂.

With reference to FIG. 3c, there can be seen a third implementation of a stream Fe₃ in accordance with the invention.

In this third implementation, the time sequences STa₁₃, . . . , STaᵢ₃, . . . , STa_{M3} that are represented by diagonal shading follow one another in time in the first sub-stream SFe₃₁ of the stream Fe₃ and they are numbered in a predetermined order that is different from the time order in which the sequences follow one another.

In the example shown, the first time sequence to be read is the i^{th} time sequence STaᵢ₃, the i^{th} time sequence read is the first time sequence STa₁₃, and the last time sequence read is the Mth time sequence STa_{M3}.

With reference to FIG. 3d, there can be seen a fourth implementation of a stream Fe₄ in accordance with the invention.

In this fourth implementation, the first sub-stream Sfe₄₁ contains two different pluralities of time sequences, a first plurality of time sequences STa₁₄, . . . , STaᵢ₄, . . . , STa_{M4}, and a second plurality of time sequences STb₁₄, . . . , STbⱼ₄, . . . , STb_{N4}.

As explained above in the description, the first plurality of time sequences is representative of a first type of summary of the audiovisual content, while the second plurality of time sequences is representative of a second type of summary of the audiovisual content.

The time sequences STa₁₄, . . . , STaᵢ₄, . . . , STa_{M4} follow one another in time and they are respectively identified by start and end of sequence markers (IDa₁₄; IFa₁₄), . . . , (IDaᵢ₄, IFaᵢ₄), . . . , (IDa_{M4}; IFa_{M4}). Such time sequences are represented by right-sloping diagonal shading in FIG. 3d.

To this end, the signaling sub-stream SFe₄₂ contains 2×M stream pointers (PDa₁₄; PFa₁₄), . . . , (PDaᵢ₄, PFaᵢ₄), . . . , (PDa_{M4}; PFa_{M4}) that are respectively associated with start and end of sequence markers (IDa₁₄; IFa₁₄), . . . , (IDaᵢ₄, IFaᵢ₄), . . . , (IDa_{M4}; IFa_{M4}).

The time sequences STb₁₄, . . . , STbⱼ₄, . . . , STb_{N4} follow one another in time and they are respectively identified by start and end of sequence markers (IDb₁₄; IFb₁₄), . . . , (IDbⱼ₄, IFbⱼ₄), . . . , (IDb_{N4}; IFb_{N4}). Such time sequences are represented by left-sloping diagonal shading in FIG. 3d.

To this end, the signaling sub-stream SFe₄₂ contains 2×N stream pointers (PDb₁₄; PFb₁₄), . . . , (PDbⱼ₄, PFbⱼ₄), . . . , (PDb_{N4}; PFb_{N4}) that are respectively associated with start and end of sequence markers (IDb₁₄; IFb₁₄), . . . , (IDbⱼ₄, IFbⱼ₄), . . . , (IDb_{N4}; IFb_{N4}).

Optionally, and as explained in the description above, each of the time sequences STa₁₄, . . . , STaᵢ₄, . . . , STa_{M4} of FIG. 3d is associated with respective audio data DAa₁₄, . . . , DAaᵢ₄, . . . , DAa_{M4}. Such audio data is synchronized with the corresponding time sequence in the signaling sub-stream SFe₄₂.

Optionally, and as explained above in the description, each of the time sequences STb₁₄, . . . , STbⱼ₄, . . . , STb_{N4} of FIG. 3d is associated with respective audio data DAb₁₄, . . . , DAbⱼ₄, . . . , DAb_{N4}. Such audio data is synchronized with the corresponding time sequence in the signaling sub-stream SFe₄₂.

The information described above with reference to the signaling sub-stream advantageously constitutes additional information associated with an audiovisual content and needed by the access terminal STB of FIG. 1 in order to perform the action commanded by the user so as to enable the user to view either the audiovisual content in full, or else a summary thereof.

Such additional information in accordance with the invention may, in a first aspect, be inserted in a “private” field of a description element of the event table of the signaling sub-stream of a broadcast data stream, where such a table is specified in the DVB-SI standard, which makes provision for so-called “private” data fields that may be used freely.

In a second aspect, a specific field could be created for the use provided by the invention, which field would be specified for example in the DVB-SI standard. That would have the advantage of obtaining universal compatibility for access terminals available on the market.

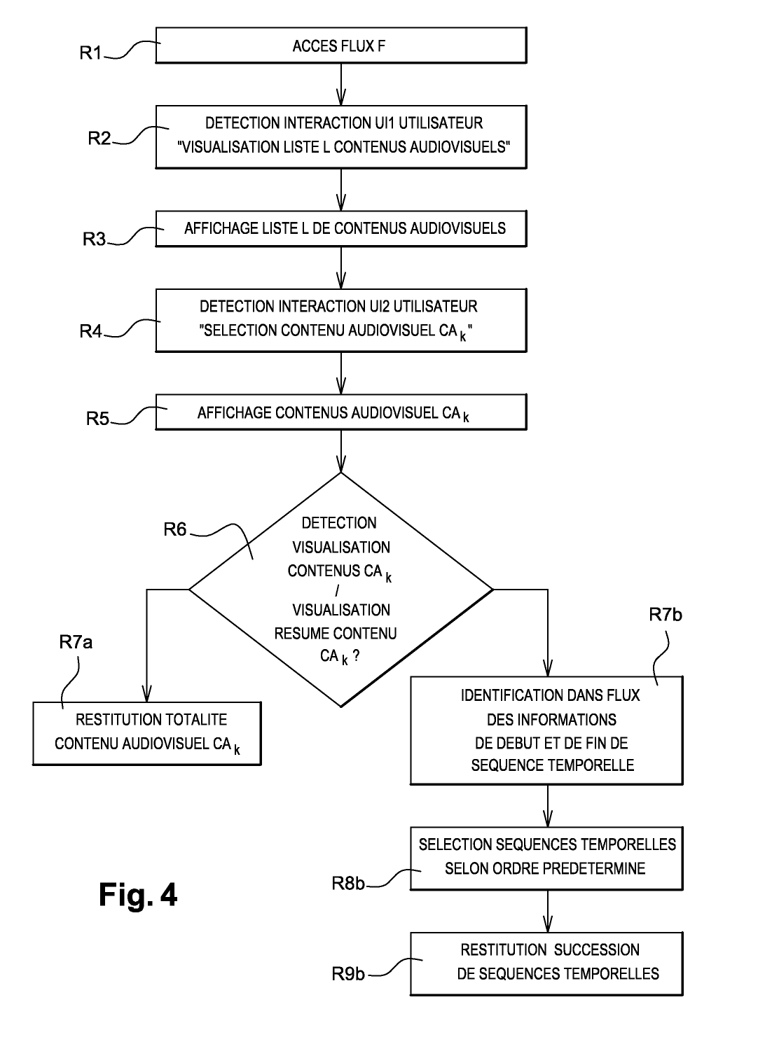

With reference to FIG. 4, there follows a description of the steps of the method in an implementation of the invention for playing back the stream representative of an audiovisual content, as performed by the access terminal STB of FIG. 1.

During a step R1 shown in FIG. 4, the access terminal STB accesses the broadcast stream as generated beforehand in application of the steps shown in FIG. 2.

The stream is accessed via an audiovisual content storage module contained in the access terminal STB and having the stream previously recorded therein or from which the stream is downloaded.

Alternatively, such an audiovisual content storage module could be external and therefore connected to the access terminal STB.

During a step R2 shown in FIG. 4, the access terminal STB detects a first interaction UI1 between the user and the remote control, requesting the display of the list of received audiovisual contents. Such an interaction UI1 is shown in FIG. 1.

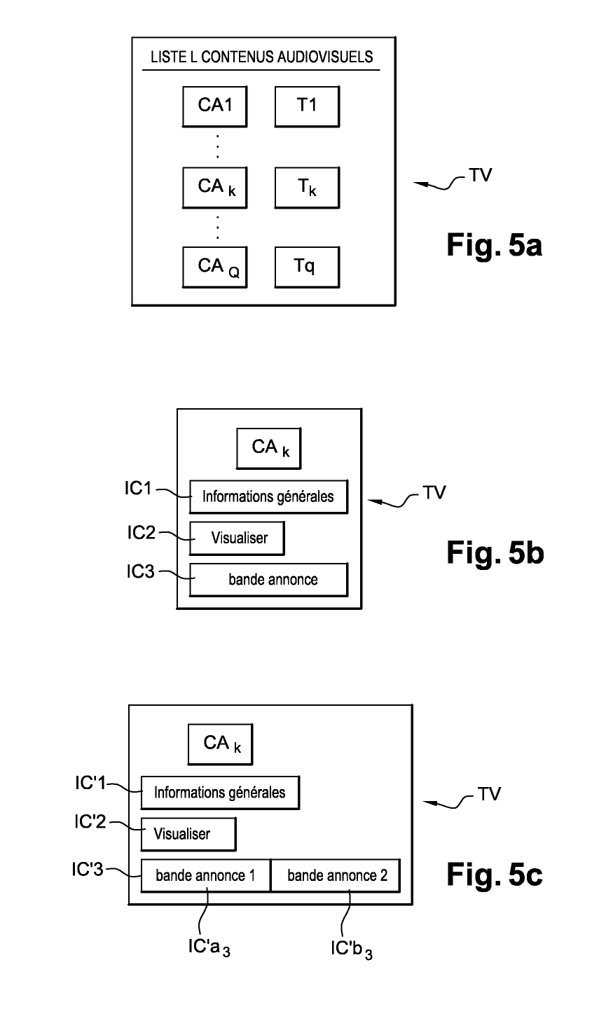

During a step R3 shown in FIG. 4, the access terminal STB responds to this request by sending a command CD1 to the television set TV of FIG. 1 to cause it to display the list L of the received terminal contents. By way of example, one such list L is shown in FIG. 5a. It comprises a succession of audiovisual contents CA₁, CA₂, . . . , CAₖ, . . . , CA_{q} (1≦k≦q), each associated with a respective title T₁, T₂, . . . , Tₖ, . . . , T_{q}.

During a step R4 shown in FIG. 4, the access terminal STB detects a second interaction UI2 of the user with the remote control, requesting selection of one of the audiovisual contents in the list L, e.g. the audiovisual content CAₖ. Such an interaction UI2 is shown in FIG. 1.

During a step R5 shown in FIG. 4, the access terminal STB responds to this request by sending a command CD2 to the television set TV of FIG. 1 to cause it to display the information about the audiovisual content CAₖ. One way in which this information can be displayed is shown by way of example in FIG. 5b. In conventional manner, there are displayed in association with a thumbnail identifying the audiovisual content CAₖ, an icon IC1, e.g. entitled “general information”, and an icon IC2, e.g. entitled “view”.

In conventional manner, the general information contains for example the year of the content, its duration, a text summary of the content, a list of the main actors in the content, etc. . . . .

In accordance with the invention, a third icon IC3, e.g. entitled “trailer”, is also associated with the audiovisual content CAₖ.

Such an interface enables the user to decide to view the audiovisual content CAₖ immediately or else, initially, to view a summary of the audiovisual content CAₖ.

A variant IC′3 of the third icon IC3 is shown in FIG. 5c in association with the audiovisual content CAₖ. In the same manner as in FIG. 5b, there are displayed in association with a thumbnail identifying the audiovisual content CAₖ, an icon IC′1 entitled “general information”, for example, and an icon IC′2 entitled “view”, for example.

In this variant, the icon IC′3 is subdivided into two sub-icons IC′a3 and IC′b3, e.g. respectively entitled “trailer 1” and “trailer 2”. Such sub-icons appear when the audiovisual content CAₖ contains, by way of example, two pluralities of different time sequences such as the first plurality of time sequences STa₁₄, . . . , STaᵢ₄, . . . , STa_{M4} and the second plurality of time sequences STb₁₄, . . . , STbⱼ₄, . . . , STb_{N4} as shown in FIG. 3d.

During a step R6 shown in FIG. 4, the access terminal STB detects a third interaction U13 of the user with the remote control, and requesting to select:
either to view the audiovisual content CAₖ in full, by selecting the icon IC2 using the remote control TC;
or else to view a summary of the audiovisual content CAₖ in full by selecting the icon IC3 with the remote control TC.

Such an interaction U13 is shown in FIG. 1.

If the detected third interaction U13 is to view the audiovisual content CAₖ in full, then during a step R7a shown in FIG. 4, the access terminal STB selects the entire audiovisual content CAₖ from said received stream, and then responds to the user's request by sending a read command CD3a to the television set TV of FIG. 1 so that it plays back the audiovisual content CAₖ to the user without searching for and automatically selecting sequences.

If the detected third interaction U13 is to display the summary of the audiovisual content CAₖ, the access terminal STB acts during a step R7b shown in FIG. 4, to identify from said stream containing the audiovisual content CAₖ:
the time sequences STa₁₁, . . . , STaᵢ₁, . . . , STa_{M1} respectively identified by the stream pointers (PDa₁₁; PFa₁₁), . . . , (PDaᵢ₁, PFaᵢ₁), . . . , (PDa_{M1}; PFa_{M1}) that are associated with the respective start and end sequence markers (IDa₁₁; IFa₁₁), . . . , (IDaᵢ₁, IFaᵢ₁), . . . , (IDa_{M1}; IFa_{M1}) when the stream in question is the stream Fe1 shown in FIG. 3a;
the time sequences STa₁₂, . . . , STaᵢ₂, . . . , STa_{M2} respectively identified by the stream pointers (PDa₁₂; PFa₁₂), . . . , (PDaᵢ₂, PFaᵢ₂), . . . , (PDa_{M2}; PFa_{M2}) that are associated with respective start and end of sequence markers (IDa₁₂; IFa₁₂), . . . , (IDaᵢ₂, IFaᵢ₂), . . . , (IDa_{M2}; IFa_{M2}) when the stream concerned is the stream Fe2 shown in FIG. 3b;
the time sequences STa₁₃, . . . , STaᵢ₃, . . . , STa_{M3} respectively identified by the stream pointers (PDa₁₃; PFa₁₃), . . . , (PDaᵢ₃, PFaᵢ₃), . . . , (PDa_{M3}; PFa_{M3}) that are respectively associated with the start and end of sequence markers (IDa₁₃; IFa₁₃), . . . , (IDaᵢ₃, IFaᵢ₃), . . . , (IDa_{M3}; IFa_{M3}) when the stream concerned is the stream Fe3 shown in FIG. 3c; and
firstly the time sequences STa₁₄, . . . , STaᵢ₄, . . . , STa_{M4} respectively identified by the stream pointers (PDa₁₄; PFa₁₄), . . . , (PDaᵢ₄, PFaᵢ₄), . . . , (PDa_{M4}; PFa_{M4}) that are associated respectively with the start and end of sequence markers (IDa₁₄; IFa₁₄), . . . , (IDaᵢ₄, IFaᵢ₄), . . . , (IDa_{M4}; IFa_{M4}), and secondly the time sequences STb₁₄, . . . , STbⱼ₄, . . . , STb_{M4} identified respectively by the stream pointers (PDb₁₄; PFb₁₄), . . . , (PDbⱼ₄, PFbⱼ₄), . . . , (PDb_{N4}; PFb_{N4}) that are associated respectively with the start and end of sequence markers (IDb₁₄; IFb₁₄), . . . , (IDbⱼ₄, IFbⱼ₄), . . . , (IDb_{N4}; IFb_{N4}), when the stream concerned is the stream Fe4 shown in FIG. 3d.

During a step R8b shown in FIG. 4, the access terminal STB searches for and then selects the time sequences identified in the predetermined order specified in the corresponding stream.

During a step R9b shown in FIG. 4, as soon as the access terminal STB selects a time sequence, it sends it to the television set TV of FIG. 1 by a read command CD2b. Said selected time sequences representative of the summary of the audiovisual content CAₖ are then played back respectively on the fly by the access terminal STB, thus enabling this summary to be displayed in fluid manner on the television set TV.

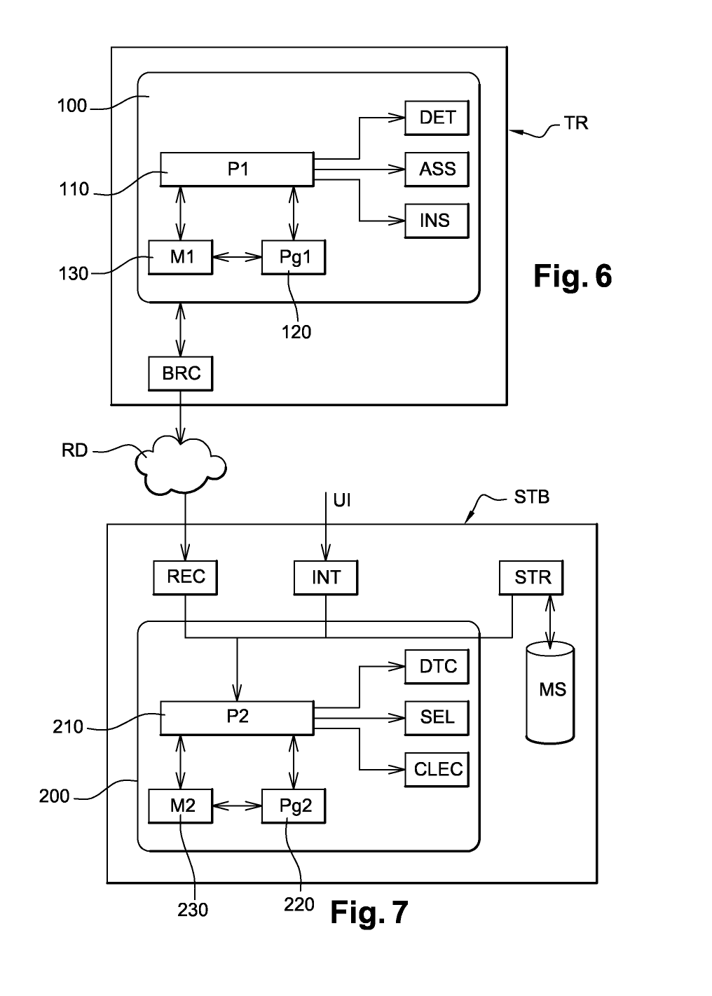

With reference to FIG. 6, consideration is given to the simplified structure of a generator device 100 for generating a stream representative of an audiovisual content in an embodiment of the invention. The generator device 100 performs the generation method of the invention as described above.

In this example, the device 100 is incorporated in headend server equipment TR of a network RD for broadcasting audiovisual data streams. In a variant, the device 100 could be independent and connected to the equipment TR. The equipment TR has a broadcast unit BRC that is adapted to broadcast the streams generated by generator device 100 over the network RD.

For example, the device 100 comprises a processor unit 110, e.g. having a processor P1, and controlled by a computer program Pg1 120 that is stored in a memory M1 130 for performing the stream generation method of the invention.

On initialization, the code instructions of the computer program Pg1 120 are loaded, for example, into a random access memory (RAM) (not shown) prior to being executed by the processor P1 of the processor unit 110. The processor of the processor unit 110 performs the steps of the above-described generation method in compliance with the instructions of the computer program Pg1 120. In the invention, the generator device 100 includes at least one determination unit DET for determining a plurality of time sequences in said audiovisual content, at least one association unit ASS for associating start and end of sequence markers with each of the determined time sequences, and at least one insertion unit INS for adding said information to the stream for broadcasting. These units are controlled by the processor P1 of the processor unit 110.

With reference to FIG. 7, there follows a description of the simplified structure of a playback device 200 for playing back a stream representative of an audiovisual content in an embodiment of the invention. The playback device 200 performs the playback method of the invention as described above.

In this example, the playback device 200 is incorporated in an access terminal STB giving access to a network for broadcasting audiovisual data streams. In a variant, the device 200 could be independent, and connected to the access terminal STB.

For example, the device 200 comprises a processor unit 210, e.g. provided with a processor P2, and controlled by a computer program Pg2 220 stored in a memory 230 and performing the playback method of the invention.

On initialization, the code instructions of the computer program Pg2 220 are loaded by way of example into a RAM (not shown) prior to being executed by the processor P2 of the processor unit 210. The processor of the processor unit 210 performs the steps of the above-described playback method in application of the instructions of the computer program 220. In the invention, the playback device 200 comprises at least one detector unit DTC for detecting an interaction UI of a user of the access terminal STB, at least one selector unit SEL for selecting from said stored stream the audiovisual content in full or else said plurality of time sequences of the audiovisual content, and at least one read control unit CLEC for reading said selected audiovisual content in full or else for reading the selected plurality of time sequences. These units are controlled by the processor P2 of the processor unit 210.

The playback device 200 is thus arranged to co-operate with the access terminal STB and in particular with the following modules of the terminal: an interaction module INT for processing user interactions; a receive module REC for receiving audiovisual content streams broadcast over the broadcast network RD; and a storage module STR for storing audiovisual contents in a storage memory MS.

The invention as described above can be applied to various kinds of usage.

By way of example, a first kind of usage consists in accessing the automatic trailer/summary of an audiovisual content broadcast live and previously stored or downloaded in the access terminal STB of FIG. 1.

In this first kind of usage, a user may for example program a plurality of audiovisual contents during the week and then at the weekend may use the interface shown in FIG. 5a to view directly on the television set TV a list of the recordings or downloads that are available. In order to make selections, the user uses the interface shown in FIG. 5b to request the trailer/summary associated with each of the recorded/downloaded audiovisual contents. The access terminal STB for any given requested audiovisual content then causes only the time sequences as identified respectively by their respective start and end of sequence markers to be displayed. These time sequences are displayed without further intervention on the part of the user concerning the selection and the duration of the sequences and without any dead time between the sequences, thereby providing an entirely fluid run of those sequences.

A second kind of usage consists in accessing a trailer/summary of a given type. As in the first kind of usage, the trailer/summary in question belongs to an audiovisual content that was broadcast live and that has already been stored or downloaded in the access terminal STB of FIG. 1.

In this second kind of usage, a user may for example store or download during holidays a plurality of episodes in a preferred series so as to avoid missing any. Imagine that the last episode of the preferred series is being broadcast direct one evening and that the user greatly wants to watch it. The user does not have the time, before the broadcast of the last episode, to view all of the missed episodes. As a result, the user chooses to access the trailer/summary of a first type, such as “important milestones” in order to be able to follow the last episode that is about to be broadcast.

It is also possible to imagine that a friend of the user does not know the series yet. As a result, the friend may choose to access the trailer/summary of a second type, such as “episode atmosphere” for the first stored or downloaded episode in order to get the gist of the series.

Naturally, the above-described embodiments and/or implementations are given purely by way of non-limiting indication and numerous modifications may easily be made thereto by the person skilled in the art without going beyond the ambit of the invention.

Thus, for example, the generation method of the invention could be performed not directly in the equipment TR of FIG. 1, but in equipment that is interposed between the equipment TR and the service platform PFS.

It is also possible, for given audiovisual content, to envisage considering more than two different types of summary. In the example of FIG. 3d, the stream Fe4 could then contain more than two sets of time sequences.

1. A generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting.

2. A generation method according to claim 1, wherein said start and end of time sequence markers are added either to the data of the audiovisual content or in broadcast parameters associated with said stream for broadcasting.

3. A generation method according to claim 1, wherein each of said determined time sequences is numbered in a predetermined order.

4. A generation method according to claim 1, further comprising the following steps:
determining (E′2), another plurality of time sequences (ST_{b1}, ST_{b2}, . . . , ST_{bj}, . . . , ST_{bN}) different from said plurality of time sequences (STₐ₁, STₐ₂, . . . , STₐᵢ, . . . , ST_{aM}) in said audiovisual content;
associating (E′3) each of said determined time sequences of said other plurality with corresponding start and end of sequence markers; and
adding (E′5) said corresponding markers to the stream for broadcasting.

5. A generation method according to claim 1, further comprising the following steps:
associating (E4) audio data with at least one of said determined time sequences; and
adding (E6) said audio data to the stream for broadcasting.

6. A generator device (100) for generating a stream representative of an audiovisual content suitable for being broadcast by a broadcast network (RD), said device being adapted to perform a generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting,
said device being characterized in that it comprises the following modules suitable for being activated prior to broadcasting said audiovisual content:
a determination module (DET) for determining a plurality of time sequences (STₐ₁, STₐ₂, . . . , STₐᵢ, . . . , ST_{aM}) in said audiovisual content;
an association module (ASS) for associating each of said determined time sequences with start and end of sequence markers; and
an insertion module (INS) for adding said markers to the stream for broadcasting.

7. A telecommunications signal carrying a stream representative of an audiovisual content for broadcasting over a broadcast network, the signal being characterized in that it includes a plurality of time sequences (STₐ₁, STₐ₂, . . . , STₐᵢ, . . . , ST_{aM}) respectively associated with start and end of sequence markers, said sequences and markers being provided by a generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting.

8. A playback method for playing back a stream representative of an audiovisual content, said stream being generated by a generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting,
said playback method being characterized in that it comprises the following steps:
accessing (R1) said stream;
from said stream, selecting (R8b) the audiovisual content in full, or else selecting said plurality of time sequences of the audiovisual content by identifying start and end of sequence markers in said stream that are respectively associated with each of said time sequences; and
causing (R9b) said selected audiovisual content to be read in full or else said selected plurality of time sequences to be read.

9. A playback method according to claim 8, wherein said step of causing selected content to be read consists in running one after another each of said time sequences corresponding respectively to each of said identified start and end of sequence markers.

10. A playback method according to claim 8, wherein said time sequences are selected in accordance with a predetermined numbering order.

11. A device for playing back a stream representative of an audiovisual content, said device being adapted to perform a playback method for playing back a stream representative of an audiovisual content, said stream being generated by a generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting,
said playback method being characterized in that it comprises the following steps:
accessing (R1) said stream;
from said stream, selecting (R8b) the audiovisual content in full, or else selecting said plurality of time sequences of the audiovisual content by identifying start and end of sequence markers in said stream that are respectively associated with each of said time sequences; and
causing (R9b) said selected audiovisual content to be read in full or else said selected plurality of time sequences to be read,
and being characterized in that it comprises the following modules:
an access module (STR) for accessing said stream;
a selection module (SEL) for selecting from said stream the audiovisual content in full, or else said plurality of time sequences of the audiovisual content by identifying start and end of sequence markers in said stream that are associated respectively with each of said time sequences; and
a read control module (CLEC) for reading said selected audiovisual content in full or else for reading said selected plurality of time sequences.

12. A computer program including program code instructions for executing steps, when executed on a computer, of a generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting.

13. A data medium containing a computer program including program code instructions for executing steps, when executed by a computer, of a generation method for generating a stream representative of an audiovisual content suitable for being broadcast by a broadcast network (RD), the method being characterized in that, prior to broadcasting said content, it comprises the following steps:
determining (E2) a plurality of time sequences (STₐᵢ, STₐ₂, . . . , STₐᵢ, . . . , ST_{aM}) in said audiovisual content;
associating (E3) each of said determined time sequences with start and end of sequence markers; and
adding (E5) said markers to the stream for broadcasting.

14. A computer program including program code instructions for executing steps, when executed on a computer, of a playback method for playing back a stream representative of an audiovisual content, said stream being generated by a generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting,
said playback method being characterized in that it comprises the following steps:
accessing (R1) said stream;
from said stream, selecting (R8b) the audiovisual content in full, or else selecting said plurality of time sequences of the audiovisual content by identifying start and end of sequence markers in said stream that are respectively associated with each of said time sequences; and
causing (R9b) said selected audiovisual content to be read in full or else said selected plurality of time sequences to be read.

15. A data medium containing a computer program including program code instructions for executing steps on a computer, of a playback method for playing back a stream representative of an audiovisual content, said stream being generated by a generation method for generating a stream representative of an audiovisual content suitable for being broadcast by a broadcast network (RD), the method being characterized in that, prior to broadcasting said content, it comprises the following steps:
determining (E2) a plurality of time sequences (STₐ₁, STₐ₂, . . . , STₐᵢ, . . . , ST_{aM}) in said audiovisual content;
associating (E3) each of said determined time sequences with start and end of sequence markers; and
adding (E5) said markers to the stream for broadcasting,
said playback method being characterized in that it comprises the following steps:
accessing (R1) said stream;
from said stream, selecting (R8b) the audiovisual content in full, or else selecting said plurality of time sequences of the audiovisual content by identifying start and end of sequence markers in said stream that are respectively associated with each of said time sequences; and
causing (R9b) said selected audiovisual content to be read in full or else said selected plurality of time sequences to be read.

16. A playback method according to claim 9, wherein said time sequences are selected in accordance with a predetermined numbering order.
